(19) United States
(12) Patent Application Publication
(10) Pub. No.: US 2025/0304870 A1
(43) Pub. Date: Oct. 2, 2025

(54) LIQUID FUEL MANUFACTURING SYSTEM AND LIQUID FUEL MANUFACTURING METHOD

(71) Applicant: HONDA MOTOR CO., LTD., Tokyo (JP)

(72) Inventors: Kota Okamura, Wako-shi (JP); Shiori Nakajima, Wako-shi (JP); Akira Sonoda, Wako-shi (JP)

(21) Appl. No.: 19/089,069

(22) Filed: Mar. 25, 2025

(30) Foreign Application Priority Data
Mar. 28, 2024 (JP) 2024-053694

(51) Int. Cl. C10L 1/04; B01J 19/00; B01J 19/24; C25B 15/02; C25B 15/08

(52) U.S. Cl. CPC C10L 1/04; B01J 19/0006; B01J 19/245; C25B 15/02; C25B 15/081; B01J 2219/00191

(57) ABSTRACT

A liquid fuel manufacturing system and a liquid fuel manufacturing method which can be operated under conditions that fuel manufacturing costs are minimized at all times are provided. A liquid fuel manufacturing system 1 includes a gasification furnace producing synthesis gas from a biomass raw material, an electrolysis apparatus producing hydrogen from water by means of electricity generated using renewable energy, a liquid fuel manufacturing apparatus manufacturing liquid fuel with synthesis gas generated by the gasification furnace and hydrogen produced by the electrolysis apparatus as raw materials, and a control device controlling the gasification furnace and the electrolysis apparatus. The control device has a cost calculation means for calculating fuel manufacturing costs, a comparison means for comparing current fuel manufacturing costs with the fuel manufacturing costs when there is no supply of hydrogen, a hydrogen supply amount adjustment means for adjusting the amount of supplied hydrogen on the basis of comparison results of the comparison means, an H₂/CO ratio calculation means for calculating an H₂/CO ratio, and an H₂/CO ratio adjustment means for adjusting the H₂/CO ratio.

### CROSS-REFERENCE TO RELATED APPLICATION

Priority is claimed on Japanese Patent Application No. 2024-053694, filed Mar. 28, 2024, the content of which is incorporated herein by reference.

### BACKGROUND OF THE INVENTION

### Field of the Invention

The present invention relates to a liquid fuel manufacturing system and a liquid fuel manufacturing method.

### Description of Related Art

In recent years, electrosynthetic fuel made from raw materials such as hydrogen produced by means of electricity generated using renewable energy and carbon sources such as biomass and carbon dioxide emitted from factories, has been attracting attention as a substitute for fossil fuels.

A general procedure of manufacturing liquid fuel such as methanol or gasoline using biomass as a raw material is as follows. That is, a liquid fuel is manufactured from biomass raw materials through a gasifying step of gasifying biomass raw materials that have undergone a predetermined pretreatment together with hydrogen, oxygen, and water vapor inside a gasification furnace and producing synthesis gas containing hydrogen and carbon monoxide, a cleaning step of cleaning the produced synthesis gas and removing tar, an H₂/CO ratio adjusting step of adjusting the H₂/CO ratio of the synthesis gas that has undergone the cleaning step to a target ratio corresponding to a liquid fuel intended to be manufactured, a desulfurizing step of removing sulfur components from the synthesis gas that has undergone the H₂/CO ratio adjusting step, and a fuel manufacturing step of manufacturing liquid fuel from the synthesis gas that has undergone the desulfurizing step.

### [Patent Document]

[Patent Document 1] Japanese Unexamined Patent Application, First Publication No. 2021-147504

### SUMMARY OF THE INVENTION

When the price of hydrogen is sufficiently low, a sufficient amount of hydrogen may be supplied as much as necessary, and when the price of hydrogen rises sharply, supply of hydrogen has to be stopped.

The present invention has been made in consideration of the foregoing problems, and an object thereof is to provide a liquid fuel manufacturing system and a liquid fuel manufacturing method which can be operated under conditions that fuel manufacturing costs are minimized at all times and which will contribute to improvement in quality control in manufacturing steps and ultimately to energy efficiency.

In order to achieve the foregoing object, the present invention provides the following means.

[1] There is provided a liquid fuel manufacturing system manufacturing liquid fuel from a biomass raw material. The liquid fuel manufacturing system includes a gasification furnace producing synthesis gas from a biomass raw material, an electrolysis apparatus producing hydrogen from water by means of electricity generated using renewable energy, a liquid fuel manufacturing apparatus manufacturing liquid fuel with synthesis gas generated by the gasification furnace and hydrogen produced by the electrolysis apparatus as raw materials, and a control device controlling the gasification furnace and the electrolysis apparatus. The control device has a cost calculation means for calculating fuel manufacturing costs, a comparison means for comparing current fuel manufacturing costs with the fuel manufacturing costs when there is no supply of hydrogen, a hydrogen supply amount adjustment means for adjusting the amount of supplied hydrogen on the basis of comparison results of the comparison means, an H₂/CO ratio calculation means for calculating an H₂/CO ratio, and an H₂/CO ratio adjustment means for adjusting the H₂/CO ratio.

The present invention can be operated under conditions that fuel manufacturing costs are minimized at all times by decreasing the amount of supplied hydrogen without stopping supply of hydrogen when the price of hydrogen rises sharply.

[2] There is provided a liquid fuel manufacturing method for manufacturing liquid fuel from a biomass raw material. The liquid fuel manufacturing method has a gasifying step of producing synthesis gas from a biomass raw material, an electrolyzing step of producing hydrogen from water by means of electricity generated using renewable energy, a liquid fuel manufacturing step of manufacturing liquid fuel with synthesis gas produced through the gasifying step and hydrogen produced through the electrolyzing step as raw materials, and a controlling step of controlling the gasifying step and the electrolyzing step. In the controlling step, current fuel manufacturing costs α and fuel manufacturing costs β when there is no supply of hydrogen are calculated, and the amount of supplied hydrogen is increased when the fuel manufacturing costs α are lower than the fuel manufacturing costs β. When the H₂/CO ratio does not match a target value, the H₂/CO ratio is adjusted to further increase the amount of supplied hydrogen when fuel costs have decreased or to return the amount of supplied hydrogen to an immediately preceding amount when the fuel costs have not decreased.

The present invention can be operated under conditions that fuel manufacturing costs are minimized at all times by decreasing the amount of supplied hydrogen without stopping supply of hydrogen when the price of hydrogen rises sharply.

According to the present invention, it is possible to provide a liquid fuel manufacturing system and a liquid fuel manufacturing method which can be operated under conditions that fuel manufacturing costs are minimized at all times.

### BRIEF DESCRIPTION OF THE DRAWINGS

FIG. 1 is a view showing the constitution of a liquid fuel manufacturing system according to an embodiment of the present invention.

FIG. 2 is a flowchart showing a liquid fuel manufacturing method according to the embodiment of the present invention.

### DETAILED DESCRIPTION OF THE INVENTION

Hereinafter, a liquid fuel manufacturing system and a liquid fuel manufacturing method according to an embodiment of the present invention will be described with reference to the drawings.

### [Liquid Fuel Manufacturing System]

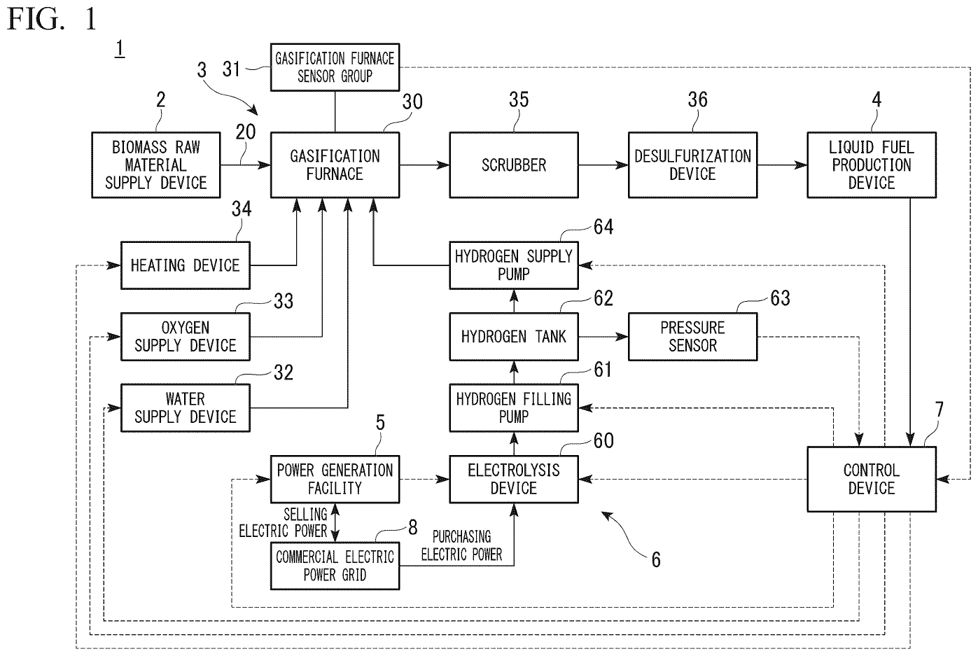

FIG. 1 is a view showing the constitution of a liquid fuel manufacturing system according to the embodiment of the present invention.

As shown in FIG. 1, a liquid fuel manufacturing system 1 includes a biomass raw material supply apparatus 2 supplying a biomass raw material, a gasification apparatus 3 gasifying a biomass raw material supplied from the biomass raw material supply apparatus 2 and producing synthesis gas containing hydrogen and carbon monoxide, a liquid fuel manufacturing apparatus 4 manufacturing liquid fuel with synthesis gas supplied from the gasification apparatus 3 and hydrogen produced by an electrolysis apparatus 60 as raw materials, a power generation facility 5 generating electricity using renewable energy, a hydrogen production supply apparatus 6 producing hydrogen and oxygen from water by means of electricity generated by the power generation facility 5 and supplying produced hydrogen and oxygen to the gasification apparatus 3, and a control device 7 controlling the gasification apparatus 3, the power generation facility 5, and the hydrogen production supply apparatus 6, thereby manufacturing liquid fuel from a biomass raw material using these.

The biomass raw material supply apparatus 2 performs a predetermined pretreatment with respect to a biomass raw material such as rice hulls, bagasse, or wood and supplies the biomass raw material that has undergone this pretreatment to a gasification furnace 30 of the gasification apparatus 3 via a raw material supply path 20. Here, for example, the pretreatment with respect to a biomass raw material includes a drying step of drying raw materials, a crushing step of crushing raw material, and the like.

The gasification apparatus 3 includes the gasification furnace 30 gasifying a biomass raw material supplied via the raw material supply path 20, a gasification furnace sensor group 31 constituted of a plurality of sensors determining the state inside the gasification furnace 30, a water supply apparatus 32 supplying water to the inside of the gasification furnace 30, an oxygen supply apparatus 33 supplying oxygen or air to the inside of the gasification furnace 30, a heating apparatus 34 heating the gasification furnace 30, a scrubber 35 cleaning synthesis gas emitted from the gasification furnace 30, and a desulfurization apparatus 36 eliminating sulfur components from synthesis gas cleaned by the scrubber 35 and supplying a result to the liquid fuel manufacturing apparatus 4.

The water supply apparatus 32 supplies water retained in a water tank (not shown) to the inside of the gasification furnace 30. The oxygen supply apparatus 33 supplies oxygen retained in an oxygen tank (not shown) to the inside of the gasification furnace 30. The heating apparatus 34 heats the gasification furnace 30 by consuming fuel supplied from a fuel tank (not shown) or electricity supplied from a power source (not shown). The amount of supplied water from the water supply apparatus 32 to the inside of the gasification furnace 30, the amount of supplied oxygen from the oxygen supply apparatus 33 to the inside of the gasification furnace 30, and the amount of input heat from the heating apparatus 34 to the gasification furnace 30 are controlled by the control device 7. In the liquid fuel manufacturing system 1, there may be no need to actively supply water from the water supply apparatus 32 to the inside of the gasification furnace 30 by supplying hydrogen from the hydrogen production supply apparatus 6 (which will be described below) to the inside of the gasification furnace 30 or to the inside of the raw material supply path 20. In this case, the water supply apparatus 32 can be excluded from the liquid fuel manufacturing system 1.

If water, oxygen, heat, and the like are input to the inside of the gasification furnace 30, to which a biomass raw material has been input, by the water supply apparatus 32, the oxygen supply apparatus 33, and the heating apparatus 34, for example, ten kinds of gasification reactions and reverse reactions thereof in total shown in the following formulas (1-1) to (1-5) progress, and synthesis gas containing hydrogen and carbon monoxide is produced inside the gasification furnace 30.

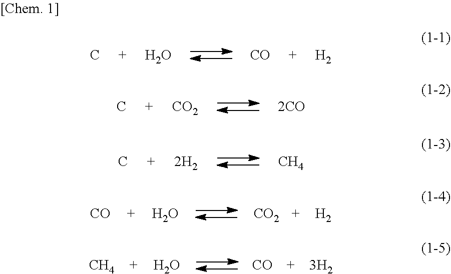

For example, the gasification furnace sensor group 31 is constituted of a pressure sensor for determining the pressure inside the gasification furnace 30, a temperature sensor for determining the temperature inside the gasification furnace 30, an H₂/CO sensor for determining the H₂/CO ratio corresponding to the ratio of hydrogen to carbon monoxide of synthesis gas inside the gasification furnace 30, a CO₂ sensor for determining carbon dioxide inside the gasification furnace 30, and the like. Determination signals of these sensors constituting the gasification furnace sensor group 31 are transmitted to the control device 7.

The gasification apparatus 3 adjusts the H₂/CO ratio of synthesis gas to a predetermined target ratio (for example, when methanol is manufactured, the target ratio of the H₂/CO ratio is 2) corresponding to the liquid fuel intended to be manufactured by mixing hydrogen supplied from the hydrogen production supply apparatus 6 (which will be described below) with synthesis gas produced due to the gasification reaction and reverse reaction thereof shown in the foregoing formulas (1-1) to (1-5), and then supplies this synthesis gas to the liquid fuel manufacturing apparatus 4.

The liquid fuel manufacturing apparatus 4 includes a methanol synthesis apparatus, a methanol-to-gasoline (MTG) synthesis apparatus, a Fischer-Tropsch (FT) synthesis apparatus, an upgrading device, and the like and manufactures liquid fuel such as methanol or gasoline from synthesis gas adjusted to a predetermined H₂/CO ratio in the gasification apparatus 3 using these.

The power generation facility 5 is constituted of a wind power generation facility generating electricity using wind power that is renewable energy, a solar power generation facility generating electricity using sunlight that is renewable energy, or the like. The power generation facility 5 is connected to the hydrogen production supply apparatus 6, and electricity generated using renewable energy in the wind power generation facility, a solar power generation facility, or the like can be supplied to the hydrogen production supply apparatus 6. In addition, the power generation facility 5 is also connected to a commercial power grid 8. For this reason, a part or all of electricity generated in the power generation facility 5 can also be sold to a power company by being supplied to the commercial power grid 8.

The hydrogen production supply apparatus 6 includes the electrolysis apparatus 60, a hydrogen filling pump 61, a hydrogen tank 62, a pressure sensor 63, and a hydrogen supply pump 64, uses these to produce hydrogen by means of electricity supplied from the power generation facility 5, and supplies produced hydrogen to the gasification apparatus 3.

The electrolysis apparatus 60 is connected to the power generation facility 5 and produces hydrogen and oxygen from water through electrolysis by means of electricity supplied from the power generation facility 5. In addition, the electrolysis apparatus 60 is also connected to the commercial power grid 8. For this reason, the electrolysis apparatus 60 can produce hydrogen and oxygen not only by means of electricity supplied from the power generation facility 5 but also by means of electricity supplied from the commercial power grid 8 by purchasing electricity from a power company. The amount of hydrogen and the amount of oxygen produced by the electrolysis apparatus 60 are controlled by the control device 7.

The hydrogen filling pump 61 compresses hydrogen produced by the electrolysis apparatus 60 and fills the inside of the hydrogen tank 62. The amount of hydrogen filled by the hydrogen filling pump 61 is controlled by the control device 7. The hydrogen tank 62 retains hydrogen compressed by the hydrogen filling pump 61. The pressure sensor 63 determines the tank internal pressure of the hydrogen tank 62 and transmits determination signals to the control device 7. The amount of hydrogen remaining inside the hydrogen tank 62 is calculated by the control device 7 on the basis of determination signals of the pressure sensor 63. Therefore, in the present embodiment, a hydrogen remaining amount acquisition means for acquiring the amount of hydrogen remaining inside the hydrogen tank 62 is constituted of the pressure sensor 63 and the control device 7.

The hydrogen supply pump 64 supplies hydrogen retained in the hydrogen tank 62 to the inside of the gasification furnace 30 of the gasification apparatus 3. The amount of supplied hydrogen from the hydrogen supply pump 64 to the inside of the gasification furnace 30 is controlled by the control device 7. In FIG. 1, a case in which hydrogen retained in the hydrogen tank 62 is supplied to the inside of the gasification furnace 30 by the hydrogen supply pump 64 will be described, but the present invention is not limited thereto. Hydrogen retained in the hydrogen tank 62 may be supplied to the upstream side of the gasification furnace 30, more specifically to the inside of the raw material supply path 20 for a biomass raw material.

The control device 7 is a computer controlling the amount of water supplied by the water supply apparatus 32, the amount of oxygen supplied by the oxygen supply apparatus 33, the amount of heat input by the heating apparatus 34, the amount of hydrogen produced by the electrolysis apparatus 60, the amount of hydrogen filled by the hydrogen filling pump 61, and the amount of hydrogen supplied by the hydrogen supply pump 64 on the basis of determination signals from the gasification furnace sensor group 31, determination signals from the pressure sensor 63 of the hydrogen tank 62, and the like.

The control device 7 has a cost calculation means for calculating fuel manufacturing costs, a comparison means for comparing current fuel manufacturing costs with the fuel manufacturing costs when there is no supply of hydrogen, a hydrogen supply amount adjustment means for adjusting the amount of supplied hydrogen on the basis of comparison results of the comparison means, an H₂/CO ratio calculation means for calculating the H₂/CO ratio, and an H₂/CO ratio adjustment means for adjusting the H₂/CO ratio.

According to the liquid fuel manufacturing system 1 of the present embodiment, it can be operated under conditions that fuel manufacturing costs are minimized at all times by decreasing the amount of supplied hydrogen without stopping supply of hydrogen when the price of hydrogen rises sharply.

### [Liquid Fuel Manufacturing Method]

A liquid fuel manufacturing method according to the embodiment of the present invention is a liquid fuel manufacturing method for manufacturing liquid fuel from a biomass raw material. The method has a gasifying step of producing synthesis gas from a biomass raw material, an electrolyzing step of producing hydrogen from water by means of electricity generated using renewable energy, a liquid fuel manufacturing step of manufacturing liquid fuel with synthesis gas produced through the gasifying step and hydrogen produced through the electrolyzing step as raw materials, and a controlling step of controlling the gasifying step and the electrolyzing step. In the controlling step, current fuel manufacturing costs α and fuel manufacturing costs β when there is no supply of hydrogen are calculated, and the amount of supplied hydrogen is increased when the fuel manufacturing costs α are lower than the fuel manufacturing costs β. When the H₂/CO ratio does not match a target value, the H₂/CO ratio is adjusted to further increase the amount of supplied hydrogen when fuel costs have decreased or to return the amount of supplied hydrogen to an immediately preceding amount when the fuel costs have not decreased.

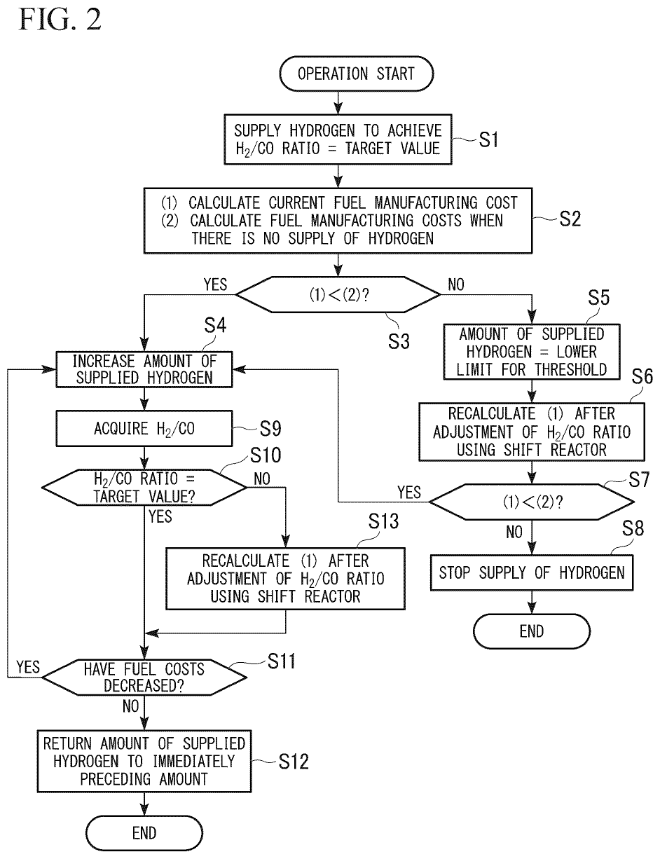

With reference to FIG. 2, the liquid fuel manufacturing method of the present embodiment will be described.

FIG. 2 is a flowchart showing a specific procedure of the liquid fuel manufacturing method of the present embodiment.

Hydrogen is supplied to the gasification apparatus 3 such that the H₂/CO ratio of synthesis gas generated in the gasification furnace 30 matches a target (Step S1).

The current fuel manufacturing costs α and the fuel manufacturing costs β when there is no supply of hydrogen are calculated (Step S2).

It is checked whether or not the fuel manufacturing costs α are lower than the fuel manufacturing costs β (Step S3). When the fuel manufacturing costs α are lower than the fuel manufacturing costs β (when YES), the amount of supplied hydrogen to the gasification apparatus 3 is increased (Step S4).

When the fuel manufacturing costs α are equal to or higher than the fuel manufacturing costs β (when NO), the amount of supplied hydrogen to the gasification apparatus 3 is set to the lower limit for a threshold (Step S5).

Thereafter, the H₂/CO ratio is adjusted, and then the current fuel manufacturing costs α are recalculated (Step S6).

Thereafter, it is checked whether or not the fuel manufacturing costs α are lower than the fuel manufacturing costs β (Step S7).

When the fuel manufacturing costs α are lower than the fuel manufacturing costs β (when YES), the processing shifts to Step S4.

When the fuel manufacturing costs α are equal to or higher than the fuel manufacturing costs β (when NO), supply of hydrogen to the gasification apparatus 3 is stopped (Step S8).

Subsequent to Step S4, the H₂/CO ratio of synthesis gas generated in the gasification furnace 30 is acquired (Step S9).

Thereafter, it is checked whether or not the H₂/CO ratio is equivalent to the target (Step S10).

When the H₂/CO ratio is equivalent to the target (when YES), it is checked whether or not the fuel manufacturing costs have decreased (Step S11).

When the fuel manufacturing costs have decreased (when YES), the processing shifts to Step S4.

When the fuel manufacturing costs have not decreased (when NO), the amount of supplied hydrogen is returned to the immediately preceding amount (Step S12).

When the H₂/CO ratio is not equivalent to the target (when NO), after the H₂/CO ratio is adjusted, the current fuel manufacturing costs α are recalculated (Step S13), and the processing shifts to Step S11.

According to the liquid fuel manufacturing method of the present embodiment, it can be operated under conditions that fuel manufacturing costs are minimized at all times by decreasing the amount of supplied hydrogen without stopping supply of hydrogen when the price of hydrogen rises sharply.

Hereinabove, an embodiment of the present invention has been described in detail. However, the present invention is not limited to the foregoing embodiment, and various modifications and changes can be made within the scope of the gist of the present invention described in the claims.

While a preferred embodiment of the invention has been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Liquid fuel manufacturing system
2 Biomass raw material supply apparatus
20 Raw material supply path
3 Gasification apparatus
30 Gasification furnace
31 Gasification furnace sensor group
32 Water supply apparatus
33 Oxygen supply apparatus
34 Heating apparatus
35 Scrubber
36 Desulfurization apparatus
4 Liquid fuel manufacturing apparatus
5 Power generation facility
6 Hydrogen production supply apparatus
60 Electrolysis apparatus
61 Hydrogen filling pump
62 Hydrogen tank
63 Pressure sensor
64 Hydrogen supply pump
65 Carbon dioxide recovery apparatus
66 Carbon dioxide tank
67 Carbon dioxide conversion apparatus
68 Fuel synthesis apparatus
7 Control device

What is claimed is:

1. A liquid fuel manufacturing system manufacturing liquid fuel from a biomass raw material, the system comprising:
a gasification furnace producing synthesis gas from a biomass raw material;
an electrolysis apparatus producing hydrogen from water using electricity generated from renewable energy;
a liquid fuel manufacturing apparatus manufacturing liquid fuel with synthesis gas generated by the gasification furnace and hydrogen produced by the electrolysis apparatus as raw materials; and
a control device controlling the gasification furnace and the electrolysis apparatus,
wherein the control device has a cost calculator for calculating fuel manufacturing costs, a comparison device for comparing current fuel manufacturing costs with the fuel manufacturing costs when there is no supply of hydrogen, a hydrogen supply amount regulator for adjusting an amount of supplied hydrogen on the basis of comparison results of the comparison device, an H₂/CO ratio calculator for calculating an H₂/CO ratio, and an H₂/CO ratio regulator for adjusting the H₂/CO ratio.

2. A liquid fuel manufacturing method for manufacturing liquid fuel from a biomass raw material, the method comprising:
a gasifying step of producing synthesis gas from a biomass raw material;
an electrolyzing step of producing hydrogen from water by means of electricity generated using renewable energy;
a liquid fuel manufacturing step of manufacturing liquid fuel with synthesis gas produced through the gasifying step and hydrogen produced through the electrolyzing step as raw materials; and
a controlling step of controlling the gasifying step and the electrolyzing step,
wherein in the controlling step, current fuel manufacturing costs α and fuel manufacturing costs β when there is no supply of hydrogen are calculated, and an amount of supplied hydrogen is increased when the fuel manufacturing costs α are lower than the fuel manufacturing costs β, and
when an H₂/CO ratio does not match a target value, the H₂/CO ratio is adjusted to further increase the amount of supplied hydrogen when fuel costs have decreased or to return the amount of supplied hydrogen to an immediately preceding amount when the fuel costs have not decreased.
